(19) United States
(12) Patent Application Publication
(10) Pub. No.: US 2026/0003591 A1
(43) Pub. Date: Jan. 1, 2026

(54) COMPUTER-IMPLEMENTED METHOD OF EXECUTING A METHOD CODE, WRITTEN IN C#, FROM ANOTHER C LANGUAGE

(71) Applicant: Siemens Industry Software Inc., Plano, TX (US)

(72) Inventor: Geoff Bones, Cambridge (GB)

(21) Appl. No.: 18/879,802

(22) PCT Filed: Jun. 29, 2022
(86) PCT No.: PCT/US2022/035610

§ 371 Date: Dec. 29, 2024

(51) Int. Cl. G06F 8/51; G06F 8/30

(52) U.S. Cl. CPC G06F 8/51; G06F 8/315

(57) ABSTRACT

A computer-implemented method of executing a method code, written in C #, from another C language is provided. The computer-implemented method includes identifying an attribution written in C #script, and identifying a method corresponding to the attribute. The method is written in the C #script. The computer-implemented method includes calling the C #method from C. In this way, legacy source code written in another language such as C or C++ may be modified by a user in C #.

This application is the National Stage of International Application No. PCT/US2022/035610, filed Jun. 29, 2022. The entire contents of this document are hereby incorporated herein by reference.

### FIELD

The present disclosure relates to a computer-implemented method of executing a method written in C #from another C language, and a non-transitory computer-readable storage medium.

### BACKGROUND

Many legacy applications have been written in a comparatively old programming language, such as C. Applications written in C are often difficult and time consuming for end users to customize, for example, by writing a method code to replace a method within the original C code. In addition, C is not very compatible for applications running over the cloud. More modern languages such as C #are more easily customizable but are not directly compatible with C source codes. Therefore, it is difficult for applications written in C to be customizable by an end user.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, the problems discussed above are addressed.

According to an aspect of the present embodiments, a computer-implemented method of executing a method coded using C #in another C language is provided. The computer-implemented method includes identifying an attribution written in C #script, identifying a method corresponding to the attribute, the method written in the C #script, and calling the C #method from C.

C #has an ability to be used for cloud-based applications, whereas C is much more difficult for such purposes. In addition, C #is easier and much quicker for end users to customize. Therefore, allowing end users to customize applications in another C language using C #improves customizability of applications for the end user.

In an embodiment, the method may be a customization of a section of source code written in C.

In an embodiment, the section of source code may include an application programming interface (API).

In an embodiment, the translating the method from C #to C may include executing Pinvoke on the method from C #.

In an embodiment, the computer-implemented method may further include retrieving the C #script from a NuGet server.

A NuGet server allows C #customizations to be loaded into a running service on the fly.

In an embodiment, the computer-implemented method may further include retrieving C #source code from disk.

Disk-resident source code enables a user to perform customizations in a development environment.

In an embodiment, the computer-implemented method may further include hosting the section of source code in a .NET environment.

In an embodiment, the computer-implemented method may further include executing the method from C.

In an embodiment, the computer-implemented method may further include converting C++ types into C types prior to the calling the C #method from C.

In this way, the conversion between C++ and C enables customizations to be made using C #for applications written in C++. C++ is an augmented language compared to C.

In an embodiment, the C++ types may include a bool, a std::string, a std::vector, a std::map, and a std::set.

In an embodiment, the converting C++ types into C types may include: converting a std::string to a char point in C; converting a std::vector to an array in C, where the array is associated with a length; converting a std::map to a key array and a value array in C, where each array is associated with a length; and converting a std::set to an array, where the array is associated with a length.

In an embodiment, the computer-implemented method may further include providing a parameter label and the method with each conversion as metadata, where the parameter label describes the C++ type.

In an embodiment, the method may be a customization of a section of source code written in C++.

In an embodiment, the section of source code may include an application programming interface (API).

In an embodiment, the computer-implemented method may further include executing the method in C++.

According to an aspect of the present embodiments, a transitory, or non-transitory, computer-readable medium, having instructions stored thereon that, when executed by a processor, cause the processor to perform the computer-implemented method of the foregoing aspect or embodiments is provided.

### BRIEF DESCRIPTION OF DRAWINGS

The present embodiments are best understood with reference to the accompanying figures, in which:

FIG. 1 shows a block diagram of a server system; and

FIG. 2 shows a computer-implemented method of executing a method code, written in C #, in another C language.

### DESCRIPTION OF EMBODIMENTS

Any methods described herein may be computer-implemented methods. The computer-implemented methods may be provided on a transitory, or non-transitory, computer-readable medium having instructions stored thereon that, when executed by a processor, cause the processor to perform the method. The processor may be a processor of a computer that also includes storage. The non-transitory computer readable medium may be store in the storage.

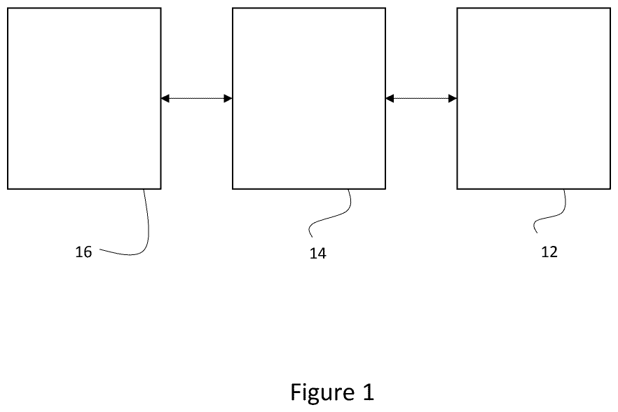

With reference to FIG. 1, a server system includes a back-end server 12, a client server 14, and a client device 16. The client device 16 may be any type of computer device and acts as an interface with a user. The client server 14 is configured to serve an editing interface for a user to edit an application. The editing interface is written in C #. The back-end server 12 includes storage including a source code of one or more applications written in C or C++. The languages C and C++ may be considered another C language.

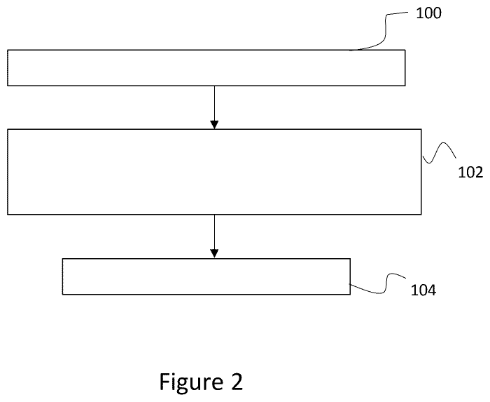

With reference to FIG. 2, in an embodiment, a computer-implemented method of executing a method code, written in C #, in another C language is provided. The method includes identifying 100 an attribute written in C #script. The method includes identifying 102 a method corresponding to the attribute, the method being written in the C #script. The method includes translating 104 the method from C #to C.

In more detail, a user may wish to customize an application written in a source code in C. To customize the code, a user may wish to write a method code using the client device 16. The method code may be written in C #. When writing the method code, the user may include an attribute to signify the existence and location of the corresponding method code.

The section of source code that the user is customizing may be an application programmable interface (API).

In one or more embodiments, the client server 14 is a web server. In this way, real-time customizations may be written by a user. In one or more other embodiments, the client server 14 is a NuGet server. A NuGet server may be for development programs.

Once the client server 14 has the C #customization written by the user, the back-end server 12 is configured to translate the method from C #to C. To achieve this, the back-end server 12 uses Pinvoke on the method written in C #.

The application or section of the source code that is being edited is hosted in a .NET environment. The .NET environment enables Pinvoke to be processed.

The computer-implemented method may further include editing the method in C. For example, the C source code is edited to replicate the method written in C #. Once the C code has been edited, the edited C code is translated to C #, where the C #code resides on the client server 14. In this way, the new method code, or customization, will load upon start-up and exist in the executing software.

There are some source code applications that are written in C++. C++ is desirable for applications because of its expanded definition of types. Those additional types not being available in C provides that equivalent commands in C #do not map directly to C++ via C.

Therefore, the method may further include converting C++ types into C types. This may be done prior to translating the method from C #to C.

The C++ types include a std::string, a std::vector, a std::map, and a std::set. Converting C++ types into C types includes converting a std::string to a char point in C and converting a std::vector to an array in C. The array is associated with a length. Converting C++ types into C types includes converting a std::map to a key array and a value array in C, where each array is associated with a length, and converting a std::set to an array, where the array is associated with a length.

In addition to the conversion, metadata is added in C for each parameter. This is so the correct parameter type may be constructed in C++. The metadata may include a parameter label and the method written in C #. The parameter label may be a description of the parameter type that may be used to replicate the method in C++.

Again, the source code in C++ may be edited to include the method written in C #, in the same, or in a similar way to how the source code in C has been edited.

Attention is directed to all papers and documents that are filed concurrently with or previous to this specification in connection with this application and that are open to public inspection with this specification, and the contents of all such papers and documents are incorporated herein by reference.

All of the features disclosed in this specification (including any accompanying claims, abstract, and drawings) and/or all of the steps of any method or process so disclosed may be combined in any combination, except combinations where at least some of such features and/or steps are mutually exclusive.

Each feature disclosed in this specification including any accompanying claims, abstract, and drawings may be replaced by alternative features serving the same, equivalent, or similar purpose, unless expressly stated otherwise. Thus, unless expressly stated otherwise, each feature disclosed is one example only of a generic series of equivalent or similar features.

The invention is not restricted to the details of the foregoing embodiments. The invention extends to any novel one, or any novel combination, of the features disclosed in this specification including any accompanying claims, abstract, and drawings, or to any novel one, or any novel combination, of the steps of any method or process so disclosed.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method of executing a method code, written in C #, from another C language, the computer-implemented method comprising:
identifying an attribution written in C #script;
identifying a method corresponding to the attribute, the method written in the C #script; and
calling the C #method from C.

2. The computer-implemented method of claim 1, wherein the method is a customization of a section of source code written in C.

3. The computer-implemented method of claim 2, wherein the section of source code comprises an application programming interface (API).

4. The computer-implemented method of claim 1, wherein calling the C #method from C #to C comprises executing Pinvoke on the method from C #.

5. The computer-implemented method of claim 1, further comprising retrieving the C #script from a NuGet server.

6. The computer-implemented method of claim 1, further comprising retrieving C #source code from disk.

7. The computer-implemented method of claim 2, further comprising hosting the section of source code in a .NET environment.

8. The computer-implemented method of claim 1, further comprising executing the method from C.

9. The computer-implemented method of claim 1, further comprising converting C++ types into C types prior to the calling the C #method from C.

10. The computer-implemented method of claim 9, wherein the C++ types comprise a pool, a std::string, a std::vector, a std::map, and a std::set.

11. The computer-implemented method of claim 10, wherein the converting of C++ types into C types comprises:
converting a std::string to a char point in C;
converting a std::vector to an array in C, wherein the array is associated with a length;
converting a std::map to a key array and a value array in C, wherein each array is associated with a length; and
converting a std::set to an array, wherein the array is associated with a length.

12. The computer-implemented method of claim 11, further comprising providing a parameter label and the method with each conversion as metadata,
wherein the parameter label describes the C++ type.

13. The computer-implemented method of claim 9, wherein the method is a customization of a section of source code written in C++.

14. The computer-implemented method of claim 13, wherein the section of source code comprises an application programming interface (API).

15. The computer-implemented method of claim 9, further comprising executing the method from C++.

16. A non-transitory computer-readable storage medium that stores instructions executable by a processor to execute a method code, written in C #, from another C language, the instructions comprising:
identifying an attribution written in C #script;
identifying a method corresponding to the attribute, the method written in the C #script; and
calling the C #method from C.
